(19) United States
(12) Patent Application Publication
(10) Pub. No.: US 2003/0184672 A1
(43) Pub. Date: Oct. 2, 2003

(54) Digital image monitoring system with functions of motion detection and auto iris

(76) Inventors: Quen-Zong Wu, Taoyuan (TW); Da-Wei Jain, Taoyuan (TW); Bor-Shenn Jeng, Taoyuan (TW); Guang-Ching Leu, Taouyan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/113,979

(22) Filed: Apr. 2, 2002

(51) Int. Cl. H04N 5/235

(52) U.S. Cl. 348/362

(57) ABSTRACT

A digital image monitoring system with functions of motion detection and auto iris which aims at the requirement of video-recording monitoring for traffic facilities, home or company which is composed of CCD camera, lens, frame grabber, illumination—reflectance decomposition unit, illumination variation detection unit and motion detection unit. The frame grabber accompanies with the CCD camera and lens to take digital images continuously. Then the illumination—reflectance decomposition unit decomposes the captured digital image and transfers it into the illumination and reflectance spectrum to provide the illumination detection unit to analyze the illumination spectrum variation between two adjacent image frames and thus this spectrum variation is used to control the amplification or reduction of the iris; beside ,an object movement detection unit is provided to analyze the illumination variation of two adjacent films to judge if the object in the frame is moving .

### BACKGROUND OF THE INVENTION

1. Field of the Invention

This invention relates to a digital image monitoring system with functions of auto iris and motion detection comprising CCD camera and lens, frame grabber, illumination—reflectance decomposition unit, illumination variation detection unit and object motion detection unit which could automatically control the amplification or reduction of the iris as well as determine whether the object in the picture is in motion or not.

2. Description of the prior Art

The traffic enforcement departments usually use the monitoring pictures of cars as evidences for the backing of traffic enforcement against drivers by means of general image monitoring system. The financial institution's security guards also use the monitoring pictures to investigate the criminal cases. The department stores usually use the image monitoring system to avoid the consumer's stealing action. The application range is so broad and with practical usage that there are numerous merchandisers paying attention to this field. Right now the simplest monitoring systems available on the markets just take pictures and record them. The advanced monitoring systems also have the ability to detect the variation of image. If the variation of image's intensities (so called Gray level) is greater than a threshold value, the monitoring system will trigger the video recorder to record the picture and send out a warning . But these systems could not eliminate the intensity variation caused by the illumination changes. Therefore, when the illumination or iris changes, which picture to vary the intensities of the picture, these systems will deem that there is a moving object. This is an erroneous judgment since actually there is no such moving object. Our invention satisfies the requirements in monitoring traffic facilities, home and enterprise. Thus it is the technology breakpoint for this invention by overcoming this major drawback and other related questions. It, a digital image monitoring system, provides the functions of auto iris and motion detection. The inventor, after several years of study and thinking, finally successfully research and complete this invention: a digital image monitoring system with functions of motion detection and auto iris. This new idea is a novel system for compromising the bottleneck faced by most vendors who could not breakthrough the technology with difficulty. The system decomposes and transfers the image into illumination and reflectance spectrum. According to these two spectrums, the system could exactly judge the illumination variation and motion variation. So, this could identify that there is a motion object or a motionless object without erroneous judgment.

### SUMMARY OF THE INVENTION

The purpose of this invention is to transform and decompose image into the spectrum of Illumination and Reflectance, and according to this it detects the change of light illumination and the motion change of objects without error—judging the condition of object—movement.

Another purpose of this invention is to provide a digital image monitor system with auto iris.

Another purpose of this invention is to provide a digital image monitor system with auto—detection of object movement.

For achieving the digital image monitor system with dual functions of auto iris and object movement detection automatically of the above—mentioned invention purpose, the system comprises: lens ,CCD camera , frame grabber, illumination—reflectance decomposition unit illumination variation detection unit and motion detection unit . The interested region parts in the image frame is captured through the frame grabber, and next the frame is transformed and decomposed into the illumination spectrum data and the reflectance data through the illumination. Reflectance decomposition unit to provide the illumination variation detection unit as detecting the change of the light illumination to control the size of the iris. And the object motion detection unit as the technology of detecting the motion change of the object to judge if there is movement on the object.

### BRIEF DESCRIPTION OF THE DRAWINGS

The drawings disclose an illustrative embodiment of the present invention which serves to exemplify the various advantages and objects hereof, and as follows:

FIG. 1 is a block diagram of the digital image monitor system with functions of motion detection and auto iris;

FIG. 2 is the motion process diagram of the image illumination variation detection unit; and

FIG. 3 is the motion process diagram of the motion detection unit.

### EXAMPLE

### DETAILED DESCRIPTION OF THE PREFERRED EMBODIMENT

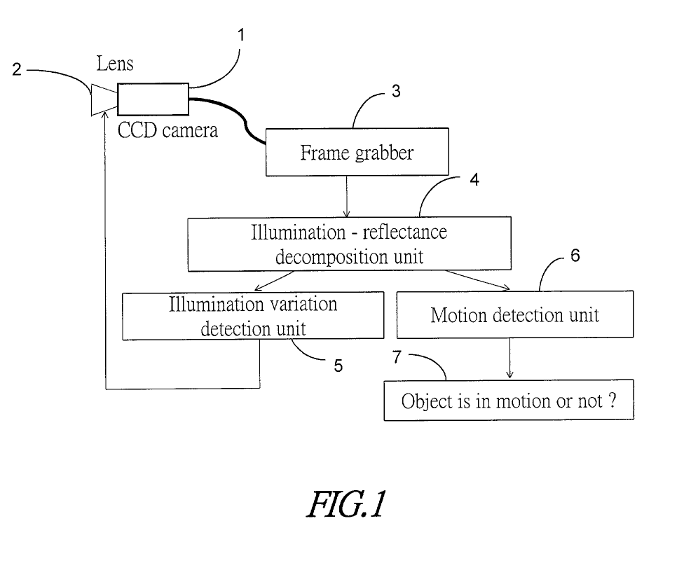

Please refer to FIG. 1. FIG. 1 shows that the system is composed of CCD camera 1 and lens 2, frame grabber 3, illumination —reflectance decomposition unit 4; illumination variation detection unit 5 and motion detection unit 6. The frame grabber accompanies with the CCD camera and lens to take the digital images continuously. Then, the illumination—reflectance decomposition unit transforms the digital image and decomposes it into the illumination and reflectance spectrum. Next, the illumination variation detection unit 5 analyzes the illumination spectrum variation between two adjacent image frames and thus it controls the amplification of this iris according to this variation; Meanwhile, the motion detection unit 6 is used to analyze the reflectance spectrum variation between two adjacent image frames which is used to judge whether the object in the picture is in motion wherein the principle of the illumination—reflectance decomposition unit is stated below: Suppose that the image resolution is M*N pixels, the intensity of pixel at coordinate (x, y) is g (x, y), where 0<x<M+1 and 0<y<N+1. The value of g (x, y) could be directly read out from CCD camera's output. Then i(x,y) and r(x,y) couldn't be directly read out from CCD camera's output. The illumination —reflectance decomposition unit at first calculates the natural log value for all pixels' intensities.

That is

$$\begin{matrix}{g}^{′} ( x , y ) = ln g ( x , y ) \\ = ln i ( x , y ) + ln r ( x , y ) \\ = {i}^{′} ( x , y ) + {r}^{′} ( x , y ) 0 < x < M + 1 , 0 < y < N + 1 ;\end{matrix}$$

Next, we utilize FFT (Fast Fourier Transfer) to process the image as follows:

$$\begin{matrix}{G}^{′} ( u , v ) = F [ {g}^{′} ( x , y ) ] \\ = F [ {I}^{′} ( x , y ) ] + F [ {r}^{′} ( x , y ) ] \\ = {I}^{′} ( u , v ) + {R}^{′} ( u , v ) , 0 < u < M + 1 , 0 < v < N + 1 ,\end{matrix}$$

I′(u, v)=F[I′(x, y)],R′(u, v)=F[r′(x, y)]

From the above equations, we know that g′(u, v)=I′(u, v)+R′(u, v). It means that the FFT of the intensities' natural log is equal to the sum of FFT of illumination natural log and FFT of the reflectance natural log. In other words, spectrum G′(x, y) is equal to the spectrum I′(u, v) plus the spectrum R′(u, v). The spectrum I′(u .v ) is mostly in low frequency band . It is reasonable that we approximate I′(u .v) as I″(u. v) at the low frequency band of G′(u. v ). Similarly, we get another approximate value R″(u. v) for R′(u .v) at the high frequency band of G′(u . v) We derive the equation as follows:

If o<u<M2 AND o<v<N/2, I″(u .v)=G′(u .v); otherwise, I″(u .v)=0

If u<m/2AND v>n/2, R″(u. v)=G′(u. v); Otherwise, R″(u .v)=o.

According to the above equations, we could directly utilize the illumination —reflectance decomposition unit to get the illumination spectrum I′(u .v) and reflectance spectrum R″(u .v).

The illumination variation detection unit calculates the difference, ΔI″, between the current illumination spectrum . new_I″(u . v), and the post illumination spectrum, old_I″(u . v) as follows:

$$Δ {I}^{″} = \frac{1}{M * N} {\sum }_{u = 1}^{M} {\sum }_{v = 1}^{N} ( {new\_I}^{″} ( u , v ) - {old\_I}^{″} ( u , v ) )$$

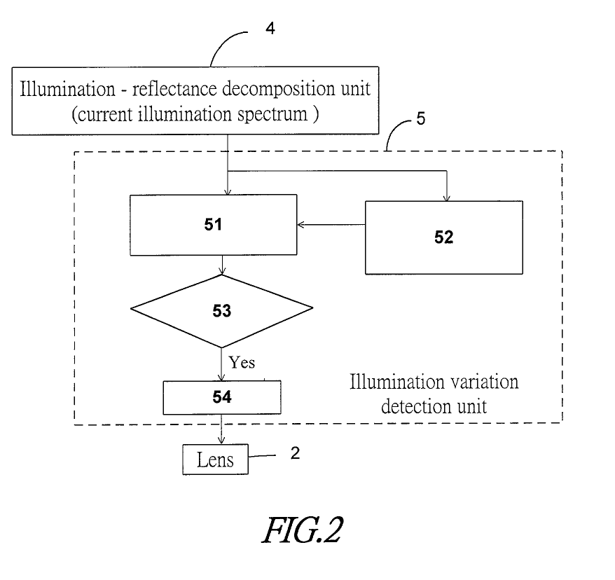

If the Δ″ value is smaller than Threshold 1, then disable the lens control signal to keep the len's iris unchanged . On the other hand, when the ΔI″ value is greater than Threshold le , Then sends the ΔI″ value to the lens to adjust the iris automatically . FIG. 2 shows the flow chart of the illumination variation detection unit.

The motion detection unit calculates the difference, ΔR″. between current Reflectance spectrum, new_R″( u . v ), and the post reflectance spectrum ,old .I″(u .v) as follows:

$$Δ {R}^{″} = \sqrt{\frac{1}{M * N} {\sum }_{u = 1}^{M} {\sum }_{v = 1}^{N} {[ {new\_R}^{″} ( u , v ) - {old\_R}^{″} ( u , v ) ]}^{2}}$$

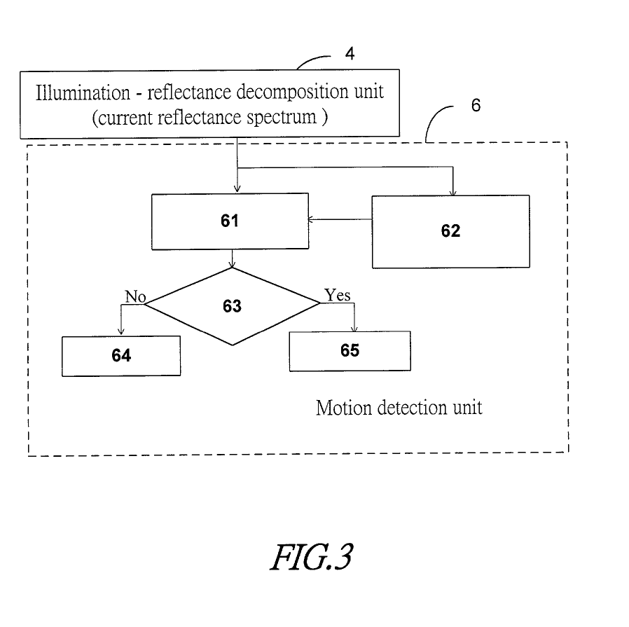

If ΔR″ is smaller than Threshold 2, it means that there is not any moving object in the picture. On the other hand, when ΔR″ is greater than Threshold 2, it means that there exists a moving object in the picture FIG. 3 shows the flowchart of the motion detection unit .

The digital image monitoring system with dual functions of automatically adjusting the lens iris and the object movement detection provided by this invention has the following advantages in comparison with the above—mentioned traditional technology:

1. It could transform the image data into the spectrum with illumination and reflectance and detect the variation of the light illumination and the movement change of object without error—judge the condition of object—moving.

2. It could grasp and process the image frames from more than one set of the CCD camera and the lens.

3. It could be setting as transforming and decomposing the interested region in frame into the illumination spectrum and the reflectance spectrum and detect the change of illumination in the interested region and the movement change of the object respectively to control the iris and to detect if the object has moved.

Many changes and modifications in the above —described embodiment of the invention can of course, be carried out without departing from the scope thereof. Accordingly, to promote the progress in science and the useful arts, the invention is disclosed and is intended to be limited only by the scope of the appended claims.

What is claimed is:

1. A digital image monitoring system comprising the units for transforming and decomposing the image into illumination spectrum and reflectance spectrum; based on these two spectrums, the system can detect variation of illumination and object motion in order to control the iris and determine weather there are moving objects.

2. The system of claim 1, wherein the digital image monitoring system comprise the features that only the regions of interest (ROI ) of the image are transformed and decomposed into the illumination spectrum and reflectance spectrum ; based on these two spectrums , the system can detect the variation of illumination and object motion in order to control iris and determine whether there are moving objects.

3. The system of claim 1 or 2, wherein the digital image monitoring system comprises the frame grabber to get images from the CCD camera.

4. The system of claim 3, wherein the digital image monitoring system comprises the features that the frame grabber could get images from two or more CCD cameras simultaneously.

5. The system of claim 1, 2, 3, or 4, wherein the digital image monitoring system comprises the features to determine, with motion detection, whether the image should be stored or not.
